(19) United States
(12) Patent Application Publication
(10) Pub. No.: US 2007/0005152 A1
(43) Pub. Date: Jan. 4, 2007

(54) Method and apparatus for monitoring power in integrated circuits

(76) Inventors: Ben Karr, Sunnyvale, CA (US); James Hermerding, San Jose, CA (US); Efraim Rotem, Haifa (IL); Oren Lamdan, Kiryat Tivon (IL)

Correspondence Address: SCHWEGMAN, LUNDBERG, WOESSNER & KLUTH, P.A., P.O. BOX 2938, MINNEAPOLIS, MN, 55402, US

(21) Appl. No.: 11/173,993

(22) Filed: Jun. 30, 2005

(51) Int. Cl. G05B 11/01; G06F 1/00

(52) U.S. Cl. 700/22; 713/323

(57) ABSTRACT

A method includes measuring a temperature of a device, determining a voltage applied to the device, determining a leakage power for the device in real time based on the measured temperature and determined voltage and estimating an active power for the device. The method also includes adding the determined leakage power and the estimated active power to estimate a total power value associated with the device, and controlling the device based on the total power value.

### BACKGROUND

There is an industry push toward reducing power consumption in computer systems. For example, some government bodies require energy compliant computing systems. The need for reducing the power consumption of computers is especially keen for battery-operated mobile computing systems, such as laptops or personal notebook computers. Because the power source of mobile computers accounts for a significant percentage of the bulk and weight of the device, attempts have been made since the advent of laptops to reduce their power consumption.

In addition, there is an ever-constant push in the computing industry to deliver computing systems having increased performance. As microprocessors and other components within a computer system become faster and smaller, thermal management becomes an important factor in preventing device or component overheating or failure. Mobile computers, such as laptop and notebook computers, are not immune to the ever-constant push to deliver higher performing systems. In mobile computing environments, thermal management is an even more important factor since the components are packed into a smaller housing. In other words, the heat generated is concentrated within the smaller housing and must be managed more effectively to prevent device or component failure. The amount of power consumed is related to the amount of heat generated by a computing system. Generally, the higher the amount of power consumed, the more heat that will be generated.

In order to effectively perform power management and thermal management in a computing system, the total power comsumption for selected components must be determined or estimated as accuarately as possible. The amount of active power used by a component cannot be used alone to project the total energy dissapated by a component or device, such as a microprocessor. Power comsumption includes not only the active power used by a component or device, but also includes the leakage power consumed by a component or device. Leakage power results from leakage current. Leakage current is inherent in devices or components that include transistors. Leakage current is current that conducts through a transistor even when the transistor is supposed to be off. In most circuit configurations, leakage current is undesirable because it consumes power without producing useful work. Leakage power consumption is inherent in semiconductor physics and is a product of the design methods used to create high speed processors. Leakage power consumption is caused by a voltage gradient across a junction within a semiconductor chip that causes current flow.

Currently, high performance devices are experiencing larger leakage currents as a percentage of total current consumption because of the greater number of transistors, with each transistor having a larger leakage current. The development of high performance devices or components, such as microprocessors, has lead to increased leakage power consumption because higher frequency devices employ smaller transistors in larger numbers than ever before. The smaller the transistor channel length and oxide thickness, the greater the leakage power consumption.

### BRIEF DESCRIPTION OF THE DRAWINGS

A better understanding of the present invention can be obtained from the following detailed description in conjunction with the following drawings, in which:

FIG. 1 is a schematic view of a computing system, according to an example embodiment.

FIG. 2 is a schematic view of a component or device that includes a temperature sensor and a voltage sensor, according to an example embodiment.

FIG. 3 illustrates a thermal influence matrix, or thermal influence table, according to an example embodiment.

FIG. 4 illustrates a graph of the indirect thermal relationship between two devices in a system according to an example embodiment.

FIG. 5 is a flowchart that illustrates a software algorithm that may be used to generate a thermal influence matrix, according to an example embodiment.

FIG. 6 is a flowchart illustrating use of the thermal influence matrix as part of a thermal management policy to thermally manage one or more devices in a system, according to an example embodiment.

FIG. 7 illustrates a device power table, according to an example embodiment.

FIG. 8 illustrates a device throttle states table, according to an example embodiment.

FIG. 9 illustrates a device throttle control object, according to an example embodiment.

FIG. 10 illustrates a thermal influence table object, also known as a thermal influence matrix or thermal proximity table (TPT), according to an example embodiment.

FIG. 11 is a schematic diagram of a computing system, according to an example embodiment.

FIG. 12 is a flow diagram of a method for thermal management of a system including at least two components that have a shared thermal solution, according to an example embodiment.

FIG. 13 is a flow diagram of a method for thermal management of a system, according to an example embodiment.

FIG. 14 is a flow diagram of a method for thermal management of a system, according to an example embodiment.

FIG. 15 is a schematic diagram of a machine accessible medium, according to an example embodiment.

### DESCRIPTION OF PREFERRED EMBODIMENTS

In the following detailed description of the preferred embodiments, reference is made to the accompanying drawings that form a part hereof, and in which are shown by way of illustration specific embodiments in which some embodiments of the invention may be practiced. It is understood that other embodiments may be utilized and structural changes may be made without departing from the scope of the present invention.

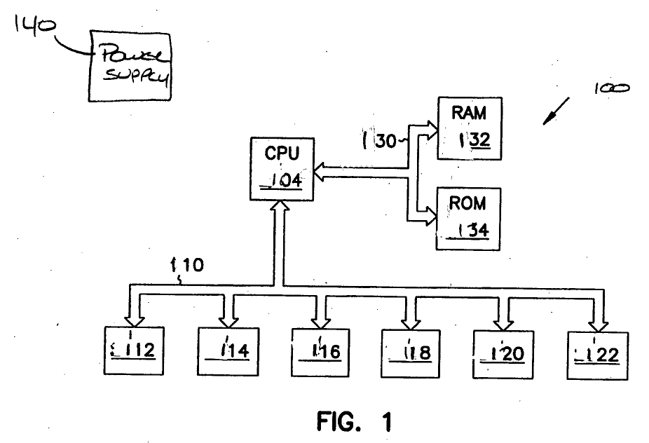

FIG. 1 is a schematic view of a system 100, such as a computer system 100, acccording to an example embodiment. The computer system 100 may also be called an electronic system or an information handling system and includes a central processing unit 104, a random access memory 132, a read only memory 134, and a system bus 130 for communicatively coupling the central processing unit 104, the random access memory 132 and the read only memory 134. The information handling system 100 also includes an input/output bus 110. One or more peripheral devices, such as peripheral devices 112, 114, 116, 118, 120, and 122 maybe attached to the input output bus 110. Peripheral devices include hard disc drives, magneto optical drives, floppy disc drives, displays, monitors, keyboards and printers, scanners, fax machines, or any other such peripherals. The information handling system 100 includes a power supply 140. In the case of a mobile information handling system 100, the power suppy 140 can include a battery which delivers power at a specific level to the central processing unit 104, the random access memory 132, and the read only memory 134. In some embodiments, the battery also supplies power at a specific level to one or more of the peripherals 112, 114, 116,118, 120, 122. A mobile information handling system 100, in some embodiments, also includes a “rectifier” for transforming alternating current to direct current that can be used in place of the battery or can be used to charge the battery associated with the power supply 140. In another example embodiment, the information handling system 100 is designed to run primarily on alternating current. These types of systems, such as a desktop computer or the like, include a power supply that transforms current from an alternating current source to voltage at a level for delivery to the central processing unit 104, the random access memory 132, and the read only memory 134. In some embodiments, the power supply 140 also supplies power at a specific level to one or more of the peripherals 112, 114, 116, 118,120, 122.

It should be noted that the information handling system or computer system 100 described above is one example embodiment of a computer system. Other computer systems can include multiple central processing units and multiple memory units. In some example embodiments, the information handling system or computer system 100 is equipped with a power management program. Many mobile computer systems implement a power management program to conserve power and extend battery life as consumers generally prefer mobile computing systems with longer battery life. Desktop computers and other computers also may implement a power management program. In a computing system 100 that implements a power management program, one or more of the various devices or components of the computer system 100 are power management enabled. Any device or component of the computer system 100 can be power management enabled. For example, the central processing unit 104, the random access memory 132 and the read only memory 134 can be power management enabled. A video card, which is an interface between the central processing unit and a monitor, can also be power management enabled. Another peripheral device that can be power management enabled is a printer. In other words, one or more of the devices or components of the information handling system or computer system 100 can include provisions through which a power management enabled operating system can put some or all of these devices or components into low-to-no function power saving modes. The devices or components are brought back to the full function normal power consumption mode of operation when the devices or components are needed.

Examples of these computer systems include ACPI compliant systems equipped with Window 95 or later (available from Microsoft Corp. of Redmond, Wash.). ACPI compliant means compliance with the Advanced Configuration and Power Interface specification, revision 1.0 or later, available from Intel Corp. of Santa Clara, Calif., a co-developer of the specification, and assignee of the present application.

In order to most effectively execute a power management program for the computer system 100, an accurate estimation or determination of the power consumption of at least one of the devices or components of the information handling system or computer system 100 is necessary. Generally, the total amount of power used by a device or component includes active power used by a component or device, and also includes leakage power consumed by a component or device. The active power is the amount of power used when the component or device is active or operating. Leakage power results from leakage current. Leakage current is inherent in devices or components that include transistors. Leakage current is current that conducts through a transistor even when the transistor is supposed to be off. Leakage current consumes power without producing useful work. As a result, the amount of active power used by a component cannot be used alone to project the total energy dissapated by a component or device, such as a microprocessor. Power comsumption includes not only the active power used by a component or device, but also includes the leakage power consumed by a component or device.

Leakage power may be measured at the end of production for each part. Generally, leakage power is a characteristic of the component or part. In order to facilitate the use the value of leakage power measured at the end of production to estimate the leakage power of a component, device or die at a later time, the component is provided with a register or memory location for storing the measured value.

Leakage power for a die or device that includes a plurality of transistors is a function of the voltage applied to the device, also known as supply voltage, and the die or device temperature. The functional relationship can be stated generally as follows:
P_{LEAK}=f(Vₙ, Tₘ)
P_{LEAK} is the amount of power that is dissapated due to leakage current at a given time. The amount of energy that is dissapated over a span of time is the summation of the various P_{LEAK} values at the various times. The functional relationship can be stated generally as follows:
E_{LEAK}=Σf(Vₙ,Tₘ)
During the operation of a die or device, the temperature of the die or device varies continuously. For example, the voltage applied to a central processing unit varies over time due to the varying current demand in the processor and due to dynamic voltage scaling for power and thermal management. The die temperature of the central processing unit varies as a function of the active power and leakage power dissipated by the central processing unit, as well as the type of workload. In addition to having various voltages applied to a component and having fluctuating temperatures on the die or device, the die or device can have areas that tend to operate at higher temperatures than other areas of the die or device. These areas are generally known as hot spots. Thus, the amount of leakage power varies continously over time and also varies with respect to the area of the die or device. To estimate or determine the leakage power associated with a particular component or device, the temperature and voltage values must be measured or estimated on the component or device.

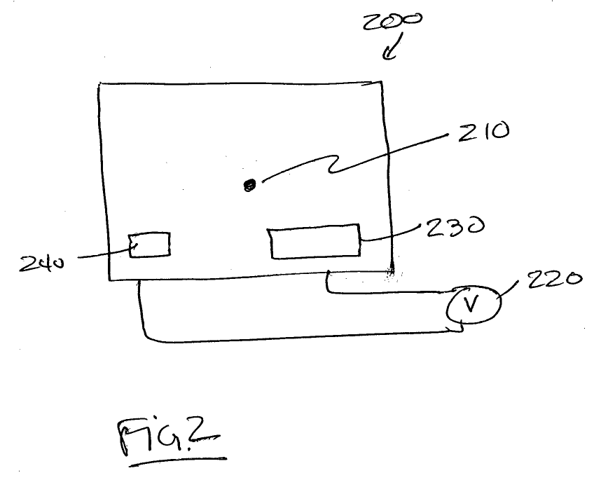

FIG. 2 is a schematic view of a component or device 200 that includes a temperature sensor 210 and a voltage sensor 220, according to an example embodiment. The component or device 200 also includes a register 230 for storing the value of the leakage power as measured at the time of production. In some embodiments, the register also stores scalar values unique to the device, die or component that can be used to determine leakage power. In still another example embodiment, the component or device 200 also includes a counter 240 for counting a number of operations over a selected time. In some embodiments, the counter measures the frequency at which the component or device 200 is operating. The temperature sensor 210 can be placed anywhere on the die or device 200. In some example embodiments, the temperature sensor 210 is placed on or near a portion of the die or component 200 that produces more heat and therefore achieves a higher temperature than the other portions of the die or component. In other words, the temperature sensor 210 can be placed on a known or suspected hot spot on the die or device 200. The voltage applied to the component or device 200 is measured by the voltage sensor 220. The voltage sensor 220 measures the voltage applied in real time or dynamically. In some embodiments, the voltage sensor 220 is off the device or component 200. As shown in FIG. 2, the voltage sensor 220 is measuring the voltage applied at two pins associated with the component or device 200. The voltage sensor 200 could be a voltmeter or the like. In other embodiments, the voltage sensor 220 is on the die or device or component. In still other example embodiments, the semiconductor device also includes a first sensor for sensing a voltage being applied to a first selected portion of the semiconductor device, and a second sensor for sensing a voltage being applied to a second selected portion of the semiconductor device.

Using the measured temperature, the measure voltage, and the value of the leakage power measured at the time of production of the component or part, the leakage power associated with the die or device 200 can be estimated or determined. In one example embodiment, the formulation for leakage power measured at the time of production includes scalars and constants. These scalars and constants are used in calculating the current or dynamic leakage power along with the measured or estimated temperature of the die or component, and the measured or estimated voltage being applied to the die or component. A formula that includes scalars and constants is set forth in the following equation:
Pₜₒₜₐₗ=cV²f+aV⁵+βV³e^{kT}
The first term in the above equation is the dynamic power, the second and third terms are the gate and sub-threshold leakage powers. Pₜₒₜₐₗ is the total power, c is the switching capacitance (typically ˜10% of the total CPU intrinsic capacitance), f is frequency, V is voltage, a and β are proportionality constants, and k is the leakage power temperature coefficient.

The active power being used by a component 200 can be estimated by monitoring counter information in the component, device or die 200. For example, in a die or device or component 200 that is mainly memory, a certain power would be assigned to a read or write command in a chipset and the active power depends on the number of reads or writes that occur in a selected time period. In still another example, the number of operations accomplished by a central processing unit is used to determine the active power consumed by the central processing unit. The particular algorithm used for determining or estimating active power, in some example embodiments, is component specific.

Once the leakage power for a device or component or die is determined in real time and once the active power for the component or die or device is determined, the total power expended by the device is determined by adding the active power and the leakage power. Since the total power is determined in real time, it is more accurate than other methods for estimating the total power output by a die or device or component. The real time or dynamically determined value for total power can be used to perform thermal management. In some computer systems, for example, a real time or dynamically determined total power value can be determined for a plurality of devices or components associated with the computer system.

In a computer system, such as computer system 100 (shown in FIG. 1), device or component temperatures may be influenced by the amount of power and the influence of thermal coupling between two devices or components. As one device or component in a system heats up or cools down due to changes in power load and thermal coupling between devices or components, that device or component may influence the temperature of another device or component in the system. Thus, the temperature of a device or component may increase or decrease due to a change in power of another device or component. The thermal effect of one device upon another may be represented in a table or matrix format.

FIG. 3 illustrates a thermal influence matrix 1000, or thermal influence table, according to an example embodiment. Each component in a system that participates in the system's thermal management policy may be represented by a row 1002 and a column 1004 in the matrix. The value of each cell 1008, 1010 of the matrix located at the intersection of each row and column represents the thermal relationship between the device or component represented by the row and the device or component represented by the column. Thus, the thermal relationships between devices or components in the system, such as computer system 100 (shown in FIG. 1), are encoded in the matrix or table.

In one embodiment, each component in the thermal influence matrix is in thermal proximity to at least one other component in the matrix. Thermal proximity is met when a change in temperature or power of one component causes the temperature of a second component in a system either to increase or to decrease. In another embodiment, all components in the thermal influence matrix are in thermal proximity to one another.

The thermal relationship between two devices, Device X and Device Y is illustrated in the form Theta[Device X:Device Y] (° C./Watt). This value represents the indirect thermal effect of Device X's power on the temperature of Device Y. A higher Theta value indicates a stronger thermal relationship between devices. For the sake of illustration, the computer system discussed includes multiple central processing units (CPUs), a memory controller hub (MCH) and an interface controller hub (ICH). Referring again to FIG. 3, the thermal relationship in position 1008, Theta[CPU:MCH], represents the indirect thermal effect of the microprocessor (CPU) on the temperature of the memory controller hub (MCH).

The thermal influence matrix may also show the direct thermal effect of a device. The direct thermal effect is the impact of a device's power on its own temperature. The direct thermal effects are illustrated in the form Theta[Device X:Device X]. For example, the thermal relationship illustrated in cell position 1010, Theta[CPU:CPU] illustrates the direct thermal path for junction to ambient of the microprocessor. The theta values for the direct thermal effects will typically be higher than the theta values for indirect thermal effects.

The thermal relationships within the thermal influence matrix are determined for a predetermined system air flow rate. Thus, a single system may require multiple thermal influence matrices to describe thermal relationships between all components for multiple air flow rates.

The actual values within a thermal influence matrix may be dependent upon the air flow within the system, the layout of components in the system, and the thermal solutions, such as heat sinks, used within the system.

The thermal influence matrix/matrices may be stored in a memory location including, but not limited to, random access memory (RAM), read only memory (ROM), flash memory, magnetic or optical storage media. In one embodiment, the data contained in the thermal influence matrix may be stored in a non-matrix or non-table format. For example, the thermal influence relationship values may be stored in consecutive locations in memory.

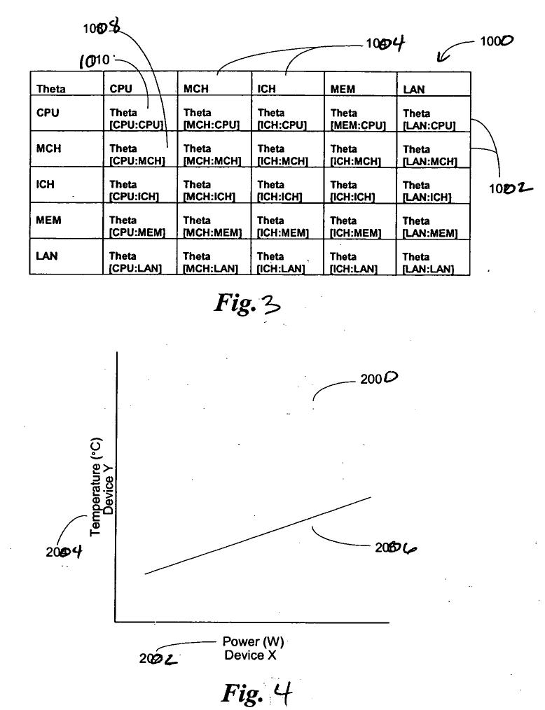

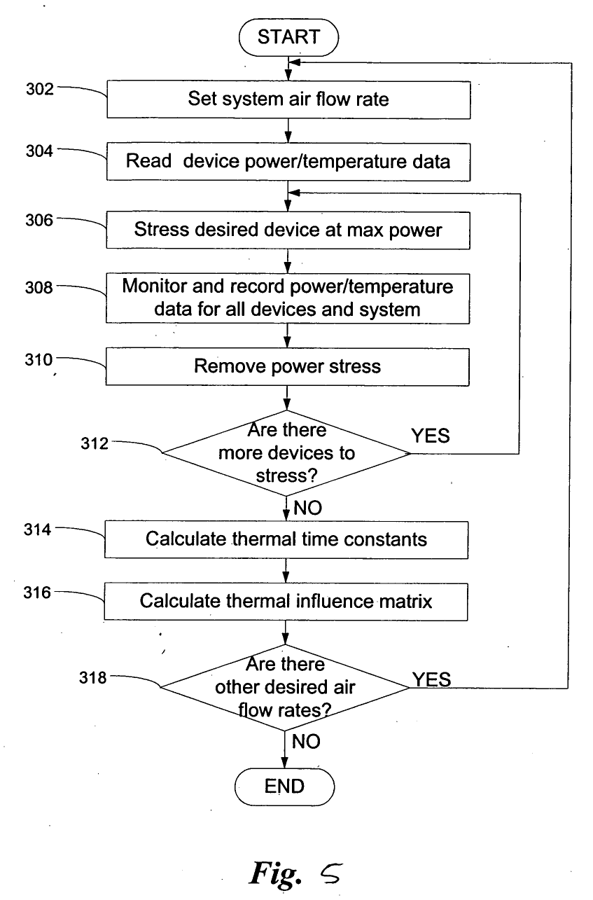

FIG. 4 illustrates a graph 2000 of the indirect thermal relationship between two devices in a system according to an example embodiment. The numerical value indicating the thermal relationship between two devices in a system, or Theta[Device X:Device Y], may be determined by taking the derivative of the temperature increase of device Y with respect to the derivative of the power of device X. Temperature 2004 represents the temperature of device Y, while Power 2002 represents the power of device X. For devices in thermal proximity to one another, the temperature of device Y will increase as the power of device X increases. The slope of the line 2006 is equal to the change of the temperature increase with respect to the change in power, or dT/dP. Thus, the numerical value of Theta[Device X:Device Y] is approximately equal to the slope of the line 2006.

The theta calculation for a direct thermal relationship, or the effect of a device's own power on its temperature, may be calculated in a similar manner by taking the derivative of the change in temperature of a component with respect to the change in power of the same component.

In one embodiment, a thermal influence matrix (or matrices) for a system may be generated by software that determines the thermal relationships between components in a system. FIG. 5 is a flowchart that illustrates a software algorithm that may be used to generate a thermal influence matrix, according to an example embodiment. First, as shown in block 302, the system air flow rate or fan speed is set. In one embodiment, the fan speed is first set to a high flow rate of approximately 3-5 cubic feet per minute (CFM). On other embodiments, the fan may be set to a lower speed, or may be turned off. Next, as shown in block 304, device power and temperature data are determined as discussed above.

After all system components reach a steady state temperature, a first device may be stressed to the level of its maximum power, or to a level substantially approaching the device's maximum power as shown by block 306. As the device power and temperature are ramping to maximum power, the temperature changes of all other components in the system may be monitored and recorded until the temperature of the first device reaches a steady state, as shown by block 308. In some embodiments, a total system power may also be recorded. In another example embodiment, two or more devices in the system may be simultaneously stressed while reading temperature data from other components in the system. The power stress is removed from the first component after it has reached steady state as depicted by block 310.

If there are additional devices that participate in the power management policy, each of these devices may be independently stressed in the same manner as the first device as depicted by block 312. As each device is stressed to its maximum power, the temperature changes of all other components in the system are recorded until the device under stress reaches a steady state temperature. When all devices have been stressed and temperature and power data recorded, thermal time constants are calculated for all components in the system using the power and temperature data that was collected as each device was stressed as depicted by block 314.

After each device has been stressed, and power/temperature data has been recorded for all system components that participate in the power management policy, the thermal influence matrix is calculated as depicted by block 316. As described above, the values in the thermal influence matrix are calculated by taking the derivative of the change in power of a first device (the stressed device) with respect to the change in temperature of another device (the other devices in the system).

As illustrated by block 318, after a thermal influence matrix has been calculated for one fluid flow rate, another thermal influence matrix may be calculated for another desired fluid flow rate. After the fluid flow rate is set (block 302), power and temperature data is read (block 304), and the devices in the system are individually stressed (block 306) while measuring the power/temperature data for other devices in the system (block 308). In this manner, thermal influence matrices can be created for all desired system fluid flow rates. In the case of an air cooled computer system, the fluid will be air. For example, for an air cooled system, each thermal influence matrix generated will correspond to one system airflow rate. In one embodiment, thermal influence matrices may be created for air flow rates ranging from zero CFM to five CFM or higher. In other systems, the fluid may be a liquid. In other systems, the fluid may be a combination of air and liquid. A thermal matrix can be produced using various flow rates in a liquid cooled system. A thermal matrix can also be produced for various combinations of liquid flow rates and air flow rates in a system cooled by a combination of air and liquid.

In one embodiment, the algorithm to calculate the system's thermal influence matrix (or matrices) may be run the first time a system is booted. In another embodiment, this algorithm may be run when the system detects a change to the system configuration that would affect the thermal properties of the system. Such changes may include the addition or removal of system components, such as memory or add-in cards, as well as upgrades of system components such as the microprocessor. Using an automated software approach allows for precise and repeatable collection of data and generation of the thermal matrix in both prototype and production environments.

Both of the thermal influence matrices and the thermal time constants are used as inputs to system thermal management mechanisms, such as a thermal management policy, that are software or hardware based. The thermal influence matrix, or thermal influence table, allows one to evaluate the impact of a change in device, or component power or temperature on the temperature of another device or component. Thus, by using the matrix and knowing the temperature and powers of other devices or components in the system, one can determine the change in temperature of any device or component due to the change in power of another device or component. For example, the temperature of each device or component can be established by the following equation, where dev_N are individual components or heat sources, P_{dev}_{_{—}}_{N} is the power of each device (W), T_{ambient} is the local ambient temperature (° C.), and Theta is measured in ° C./W as described above:
T_{dev}_{_{—}}_{B}=T_{ambient}+Theta[dev_{—}A:dev_{—}B]*P_{dev-A}+
Theta[dev_B:dev_B]*P_{dev}_{_{—}}_{B}+TGheta[dev_C:dev_B]*P_{dev}_{_{—}}_{C}+ . . . +
Theta[dev_N:dev_B]*P_{dev}_N

The ability to establish this thermal relationship between components is useful when many integrated circuit components or other heat generating devices exist within a single enclosure. Knowing the thermal relationships between components allows a system designer to focus on problem areas by quickly observing which devices can influence the temperature of others, and redesigning airflow, placement, or cooling solutions to solve thermal issues.

In various example embodiments, the thermal influence matrix is used for thermal management of a system by an operating system (OS), device driver, hardware, or other software or firmware mechanisms to evaluate which devices in a system may be contributing to the temperature of a “hot” device. A hot device may be defined as a device that is approaching or that exceeds a predetermined threshold temperature. Based upon this evaluation, algorithms may be enabled to determine which device(s) power or performance should be reduced in order to have the greatest influence on reducing the temperature of the hot device. Thus, if device A is getting too hot, use of the thermal influence matrix may allow a power management algorithm to determine what devices have the greatest influence on device A's temperature. The algorithm may then reduce the power of one or more of the influential device(s) in order to lower the temperature of device A.

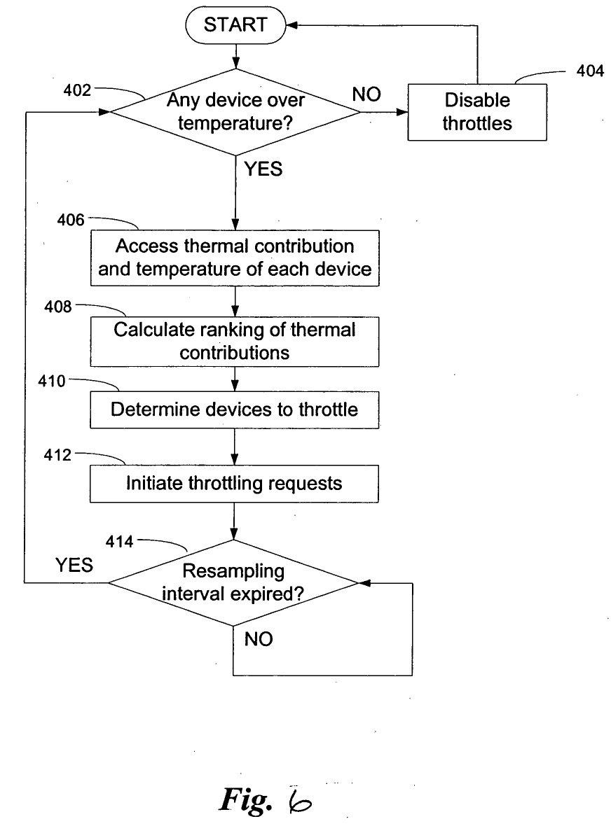

FIG. 6 is a flowchart illustrating use of the thermal influence matrix as part of a thermal management policy to thermally manage one or more devices in a system, according to an example embodiment. The thermal management policy may be implemented by an operating system (O/S), device drivers, firmware, or other hardware or software. For example, a device driver may provide an interface to get or to set any of the values defined by the thermal management policy, including but not limited to temperature, power level, and performance/throttle states. First, a determination is made whether any device in a system is over temperature 402. If no device is over temperature, then all throttles may be disabled 404. If any device is over its predetermined threshold temperature, the thermal contribution and temperature of each device is accessed 406. Using the thermal contribution and temperature of each device in conjunction with a thermal influence matrix, a ranking of thermal contributions may be calculated 408. Based upon the ranking of thermal contributions, the thermal management policy may determine which devices to throttle 410.

In one embodiment, the determination of which devices to throttle may be made based upon those devices that are in a top predetermined percentage of the thermal contribution ranking. For example, the devices that are in the top 25% of the ranking may be throttled. In another embodiment, the top N devices may be throttled, where N is a predetermined number between 1 and the number of devices participating in the thermal management policy.

Next, throttling requests are initiated to those devices that will be throttled 412. Throttling a component may include reducing power or reducing power dissipation by the component. Throttling may be done by reducing the operating frequency of a device, reducing power to the device, disabling functional blocks in the system, or in any other way which would reduce the power or power dissipation of the component.

After a predetermined resampling interval has expired 414, the thermal management policy, which may comprise the O/S or thermal management software, will repeat the algorithm at block 402 by determining if any device is over temperature.

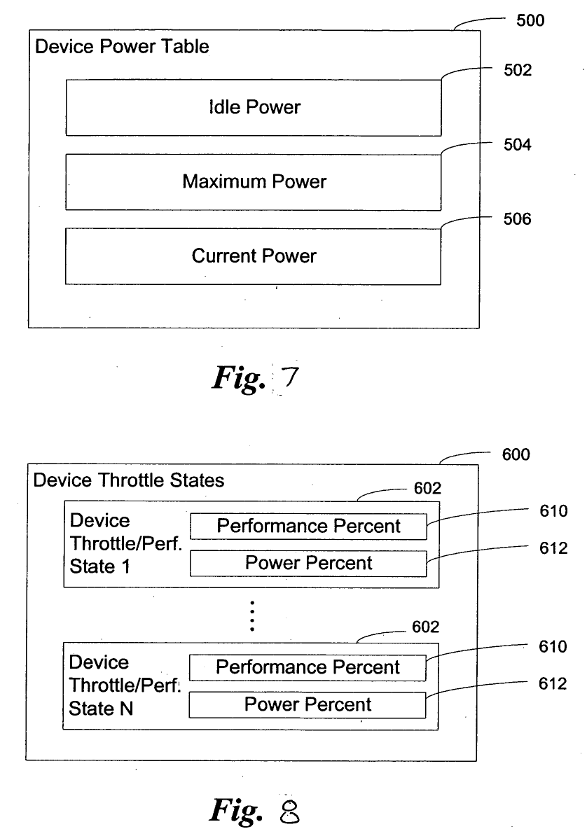

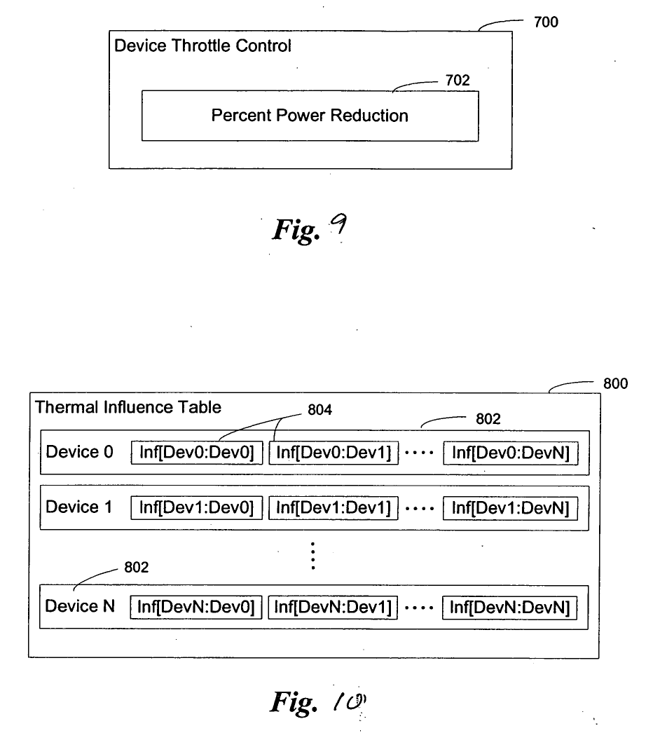

FIGS. 7-10 illustrate software reporting structures used by a thermal management policy to determine which devices to thermally manage in a system, according to an example embodiment. The software reporting structure may include one or more device power tables, one or more device throttle state tables, a device throttle control object, and one or more thermal influence tables. Many other embodiments are possible as well, including the use of hardware registers, memory mapped I/O, or device driver native interfaces to determine which device(s) to thermally manage.

FIG. 7 illustrates a device power table 500, according to an example embodiment. The device power table 500 contains relevant power information for a device. The device power table 500 may include information about idle power 502, maximum power 504, and current power 506. A thermal management policy may use these three parameters to determine the influence of one particular device on other devices that are designated to be in thermal proximity to one another. There may be a device power table for each device that participates in the system thermal management policy.

The device idle power 502 represents idle or leakage power when the device is in the D0 state (fully on and operational), but not actively in use. Local power management techniques may be applied and accounted for in the idle power calculation. The idle power number represents typical leakage power dissipation. The device maximum power 504 represents the maximum power of the component. This number may represent the highest power under operating conditions not exacerbated through the use of synthetic workloads, such as a power virus. Typically, this number will represent the thermal design power level of the device. The device current power 506 represents the power dissipation average across a thermally-significant period of time. This number is commonly represented by maximum power scaled by some utilization factor, but may be determined in a different manner depending on the device vendor's implementation.

FIG. 8 illustrates a device throttle states table 600 according to an example embodiment. The device throttle states 600 table lists throttle and/or performance states associated with a particular device. The throttle and performance states may include a performance percent 610 and a power percent 612. The performance percentage 610 indicates a decrease in device performance as a percentage of maximum performance. The power percentage 612 indicates a decrease in device power as a percentage of maximum power. There may be a device throttle states table for each device that participates in the system thermal management policy.

The throttle states represent states that reduce performance and power in a linear or sub-linear fashion (performance reduction %>=power reduction %). The performance states represent states that reduce performance and power in a non-linear fashion (performance reduction %<power reduction %). The thermal management policy may make a request for a device to operate in a lower power state by making use of the throttle/performance state information reported in the device throttle states table 600. The device may be responsible for prioritizing requests to use performance states (non-linear) as the first step to reaching the required power reduction, followed by throttling (linear) states once the device has reached the lowest performance state.

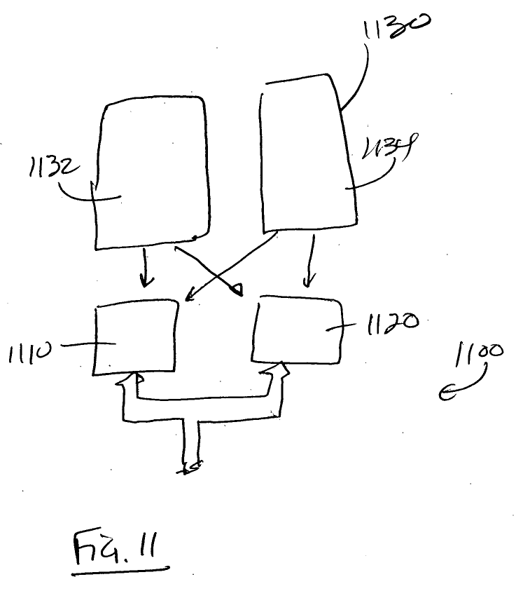

FIG. 9 illustrates a device throttle control object 700 according to an example embodiment. The device throttle control object 700 allows the thermal management policy to reduce the power contribution of a particular device by placing a request to the device to reduce its power consumption as a function of percent of currently utilized power. The thermal management policy may calculate the necessary reduction required as a result of using the current power dissipation as well as the proximity of the device. The device may be responsible for prioritizing requests to use performance states (non-linear) as the first step to reaching the required power reduction, followed by throttling states (linear) once the device has reached the lowest performance state.

The argument of this object, percent power reduction 702, defines the percent power reduction required by the thermal management policy. The method is responsible for mapping this request to the appropriate performance and/or throttle state associated with the actual device, as defined in the device throttle states table. The power reduction must meet the minimum requested by the thermal management policy. In one embodiment, the device throttle control object may return a value that indicates the percent power reduction (relative to maximum power) that was initiated.

FIG. 10 illustrates a thermal influence table object 800, also known as a thermal influence matrix or thermal proximity table (TPT), according to an example embodiment. The thermal influence table object 800 describes the thermal relationships between the device and other thermally-related devices. The thermal influence table object of FIG. 10 is a variation of that which is described in FIG. 3. The thermal influence table is described in detail above in conjunction with FIGS. 3-5. Dynamic generation of the table is described above in conjunction with FIG. 6. For each relationship in the table, the device name 802 is listed, followed by the theta (° C./W) between the devices 804. A thermal management policy may use this information to determine which device(s) should be thermally managed. In one embodiment, the thermal influence table object may be implemented in ACPI (Advanced Configuration and Power Interface) format, in accordance with the ACPI Specification, Revision 3.0, published Sep. 2, 2004. In this embodiment, the device name used is the ACPI device name.

The thermal influence between devices, or theta 804, is a number that represents the temperature influence on one device for a given change in power of another device, as described above. In one embodiment, this value is scaled by a scaling factor to allow for additional precision of theta values. The scaling factor may be a multiple of 10. In one embodiment, the scaling factor is equal to 1000. For a given device, a thermal management policy can rank the influence of each device on a desired device by evaluating the desired device's current power dissipation multiplied by the influence factor, theta. This factor gives a weighting of the amount of temperature influence that a particular device contributes relative to other devices participating in the power management policy. By ranking all of the contributions, the thermal management policy can determine which device(s) to throttle in order to thermally manage a desired device. A thermal management policy may also use the thermal influence table to calculate the required power reduction needed on the throttled devices in order to achieve a given temperature reduction on the desired device.

FIG. 11 is a schematic diagram of a computing system 1100, according to an example embodiment. The computing system 1100 includes a first component or device 1 110 and a second component 1120 or device that has a common or shared thermal solution 1130. The first and the second component can be a pair of central processing units, a central processing unit and a processor associated with a video card, or any other combination of components associated with a computer system. It should also be noted that there can also be more than two components or devices that have a common or shared thermal solution 1130. The shared thermal solution 1130 includes a first fluid mover 1132 and a second fluid mover 1134. The fluid handled by the first fluid mover 1132 and the second fluid mover 1134 can be air, a gas, a liquid coolant or the like. The shared thermal solution 1130 can be controlled to shift the fluid between the first component or device 1110 and the second component 1120. As a result, when a device or component is running hot (close or near to a desired temperature) additional cooling fluid (air or liquid) can be diverted from another device to provide additional cooling to the device or component that is running hot. In short, the cooling fluid can be shifted to a component or device that requires additional cooling. A thermal matrix can also be produced for various flows of fluid in the system 1100 so that a thermal management solution can be selected in which fluids (liquid or gas) can be switched or diverted between a first component 1110 and a second component 1120.

The thermal solution can include enabling or disabling fluid movers 1132, 1134 in various combinations, or diverting fluid flow from one of the first component 1110 or the second component 1120 to cool the other of the first component 1110 or the second component 1120. The total power is determined in real time or dynamically to provide a precise and realistic solution. By monitoring component leakage power and actual power in real time, estimates of specification breaches could also be made in real time and the component about to run hot or breech a specification can be provided with additional cooling. This could be used as an alternative thermal management solution to immediately throttling a component and losing performance. In some instances, shifting cooling fluid to the component about to breech the specification or run hot allows the component to continue operating at a high level of performance for some additional time. This solution could also be used in combination with throttling the component. In such a scenario, the performance drop due to throttling could be lessened by either throttling back by a smaller increment or by shortening the time necessary before the component or device returns to operating at a higher performance level.

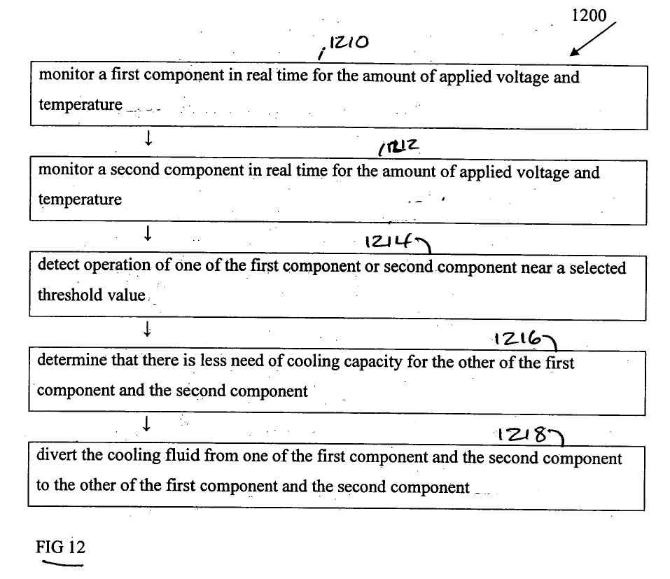

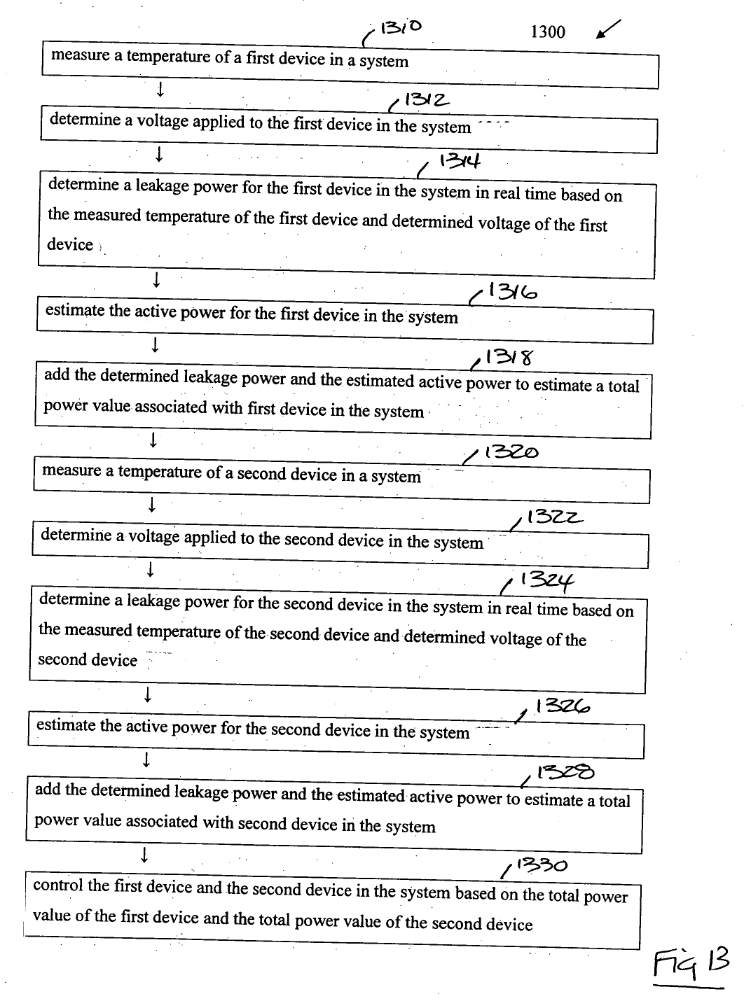

FIG. 12 is a flow diagram of a method 1200 for thermal management of a system including at least two components that have a shared thermal solution, according to an example embodiment. The method 1200 includes monitoring a first component in real time for the amount of applied voltage and temperature 1210, monitoring a second component in real time for the amount of applied voltage and temperature 1212, detecting operation of one of the first component or second component near a selected threshold value 1214, determining that there is less need of cooling capacity for the other of the first component and the second component 1216, and diverting the cooling fluid from one of the first component and the second component to the other of the first component and the second component 1218.

FIG. 13 is a flow diagram of a method 1300 for thermal management of a system, according to an example embodiment. The method 1300 includes measuring a temperature of a first device in a system 1310, determining a voltage applied to the first device in the system 1312, and determining a leakage power for the first device in the system in real time based on the measured temperature of the first device and determined voltage of the first device 1314. The method 1300 further includes estimating the active power for the first device in the system 1316, and adding the determined leakage power and the estimated active power to estimate a total power value associated with first device in the system 1318. The method 1300 also includes measuring a temperature of a second device in a system 1320, determining a voltage applied to the second device in the system 1322, and determining a leakage power for the second device in the system in real time based on the measured temperature of the second device and determined voltage of the second device 1324. The method 1300 also includes estimating the active power for the second device in the system 1326, adding the determined leakage power and the estimated active power to estimate a total power value associated with the second device in the system 1328; and controlling the first device and the second device in the system based on the total power value of the first device and the total power value of the second device 1330. Controlling the first device includes controlling the voltage applied to the first device, or thermally managing the first device, or both. Controlling the second device includes controlling the voltage applied to the second device, thermally managing the second device, or both. Controlling the first device and the second device 1330 includes moving cooling capacity from the first device to the second device, or controlling the speed of a fan, or controlling the flow of a coolant within a system. Of course, a combination of these thermal controls can also be used in some example embodiments. Controlling the first device and the second device 1330, in some embodiments, includes consideration of an interaction between the first device and the second device when a control method is applied to at least one of the first device and the second device. The interactions can be considered by producing a thermal matrix of the first and second component at various flows associated with a first fluid mover and a second fluid mover.

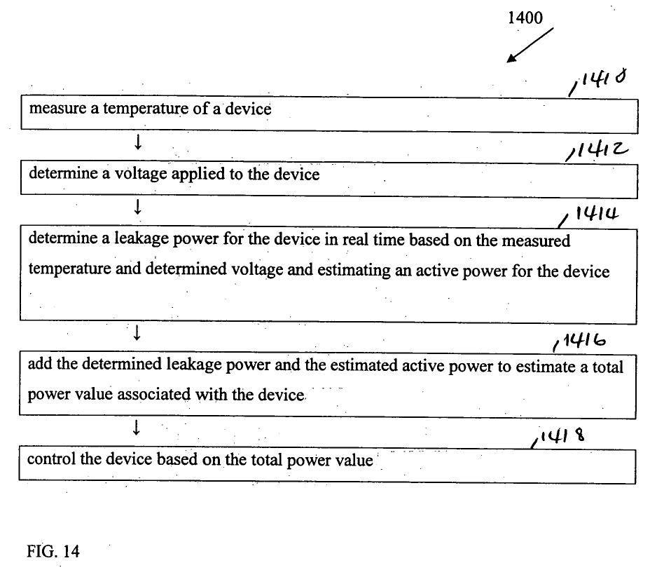

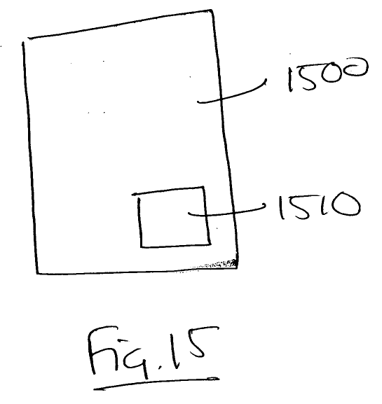

FIG. 14 is a flow diagram of a method 1400 for thermal management of a system, according to an example embodiment. The method 1400 includes measuring a temperature of a device 1410, determining a voltage applied to the device 1412, determining a leakage power for the device in real time based on the measured temperature and determined voltage and estimating an active power for the device 1414. The method 1400 also includes adding the determined leakage power and the estimated active power to estimate a total power value associated with the device 1416, and controlling the device based on the total power value 1418. Controlling the device based on the total power value 1418 includes throttling back the voltage applied to the device or thermally managing the device. In some embodiments, controlling the device based on the total power value includes throttling back the voltage applied to the device, and thermally managing the device. Thermally managing the device includes controlling the speed of a fan, or controlling the flow of a coolant, or shifting cooling capacity from one device to another device.

FIG. 15 is a schematic diagram of a machine-readable medium 1500 that includes a set of instructions 1510, according to an example embodiment. The machine-readable medium stores a set of instructions that when executed, by a machine, cause the machine to perform operations including measuring a temperature of a device, determining a voltage applied to the device and determining a leakage power for the device in real time based on the measured temperature and determined voltage. The set of instructions 1510 further cause the machine to perform estimating an active power for the device, adding the determined leakage power and the estimated active power to estimate a total power value associated with the device, and controlling the device based on the total power value. Controlling the device with the machine accessible medium includes controlling the voltage applied to the device, or throttling back the voltage applied to the device. Controlling using the total power value includes throttling back the voltage applied to the device, or thermally managing the device, or both. Thermally managing the device includes controlling the speed of a fan, or controlling the flow of a coolant, or shifting cooling capacity from one device to another device.

It is understood that the above description is intended to be illustrative, and not restrictive. Many other embodiments will be apparent to those of skill in the art upon reviewing the above description. The scope of the invention should be, therefore, determined with reference to the appended claims, along with the full scope of equivalents to which such claims are entitled.

What is claimed is:

1. A method comprising:
measuring a temperature of a device;
determining a voltage applied to the device;
determining a leakage power for the device based on the measured temperature and determined voltage;
estimating an active power for the device;
adding the determined leakage power and the estimated active power to estimate a total power value associated with the device; and
controlling the device based on the total power value.

2. The method of claim 1, wherein controlling the device based on the total power value includes throttling back the voltage applied to the device.

3. The method of claim 1, wherein controlling the device based on the total power value further comprises:
throttling back the voltage applied to the device; and
thermally managing the device.

4. The method of claim 1, wherein controlling the device based on the total power value includes thermally managing the device.

5. The method of claim 4, wherein thermally managing the device includes controlling the speed of a fan.

6. The method of claim 4, wherein thermally managing the device includes controlling the flow of a coolant.

7. The method of claim 4, wherein thermally managing the device includes shifting cooling capacity from one device to another device.

8. The method of claim 1 comprising:
measuring a temperature of a second device in a system;
determining a voltage applied to the second device in the system;
determining a leakage power for the second device in the system in real time based on the measured temperature of the first device and determined voltage of the first device;
estimating the active power for the second device in the system;
adding the determined leakage power and the estimated active power to estimate a total power value associated with second device in the system; and
controlling the first device and the second device in the system based on the total power value of the first device and the total power value of the second device.

9. The method of claim 8, wherein controlling the first device includes controlling the voltage applied to the first device.

10. The method of claim 9, wherein controlling the first device includes thermally managing the first device.

11. The method of claim 9, wherein controlling the second device includes controlling the voltage applied to the second device.

12. The method of claim 1 1, wherein controlling the second device includes thermally managing the second device.

13. The method of claim 8, wherein controlling the first device and the second device includes moving cooling capacity from the first device to the second device.

14. The method of claim 8, wherein controlling the first device and the second device includes controlling the speed of a fan.

15. The method of claim 8, wherein controlling the first device and the second device includes controlling the flow of a coolant.

16. The method of claim 8, wherein controlling the first device and the second device includes consideration of an interaction between the first device and the second device when a control method is applied to at least one of the first device and the second device.

17. A machine accessible medium to store a set of instructions that when executed, by a machine, cause the machine to perform operations comprising:
measuring a temperature of a device;
determining a voltage applied to the device;
determining a leakage power for the device in real time based on the measured temperature and determined voltage;
estimating an active power for the device;
adding the determined leakage power and the estimated active power to estimate a total power value associated with the device; and
controlling the device based on the total power value.

18. The machine-readable medium of claim 17, wherein controlling the device includes controlling the voltage applied to the device.

19. The machine-readable medium of claim 17, wherein controlling using the total power value includes throttling back the voltage applied to the device.

20. The machine-readable medium of claim 17, wherein controlling using the total power value includes thermally managing the device.

21. The machine-readable medium of claim 20, wherein thermally managing the device includes controlling the speed of a fan.

22. The machine-readable medium of claim 20, wherein thermally managing the device includes controlling the flow of a coolant.

23. The machine-readable medium of claim 20, wherein thermally managing the device includes shifting cooling capacity from one device to another device.

24. A semiconductor device comprising:
a temperature sensor positioned to sense a temperature associated with a semiconductor device; and
a register to store leakage power information measured at the time of manufacture of the semiconductor device.

25. The semiconductor device of claim 24 further comprising a sensor to sense a voltage being applied to the semiconductor device.

26. The semiconductor device of claim 24 further comprising a counter to count a number of operations of the semiconductor device.

27. A system comprising:
a device to dynamically determine a total power for a first component and to dynamically determine a total power for a second component, wherein the total power, for each component, includes a dynamically determined value of leakage power and an estimated value of the active power;
a thermal management system for the system, the thermal management system to control a cooling system to cool the first component and the second component;
a controller to control the operation of the first component, the operation of the second component, and the operation of the thermal management system; and
a display.

28. The system of claim 27 wherein the first component further comprises:
a temperature sensor positioned to sense a temperature associated with the first component;
a voltage estimator to estimate a voltage being applied to the first component; and
a register to store a previously measured value of leakage power associated with the first component;
and wherein the second component further comprises:
a temperature sensor positioned to sense a temperature associated with the second component;
a voltage estimator to estimate a voltage being applied to the second component; and
a register to store a previously measured value of leakage power associated with the second component.

29. The system of claim 27 further comprising a device to dynamically determine a leakage power for the first component and the second component, based on a sensed temperature, an estimated voltage and the value stored in the register related to a previously measured leakage power of a particular component.

30. The system of claim 27 further including a subsystem to determine the affect that controlling one of the first component or the second component has on the other of the first component or the second component.
